(19) United States
(12) Patent Application Publication
(10) Pub. No.: US 2015/0063618 A1
(43) Pub. Date: Mar. 5, 2015

(54) HOUSING ASSEMBLY

(71) Applicant: Chiun Mai Communication Systems, Inc., New Taipei (TW)

(72) Inventors: CHUN-JEN CHEN, New Taipei (TW); KUANG-HSIEN WANG, New Taipei (TW)

(73) Assignee: Chiun Mai Communication Systems, Inc., New Taipei (TW)

(21) Appl. No.: 14/160,517

(22) Filed: Jan. 21, 2014

(30) Foreign Application Priority Data
Sep. 4, 2013 (CN) 2013205468790

(51) Int. Cl. H04R 1/02

(52) U.S. Cl. CPC H04R 1/025
USPC 381/332

(57) ABSTRACT

A housing assembly includes a housing and a speaker module. The housing defines a slot. The speaker module is assembled to the housing. The speaker module includes a speaker and a base. The speaker is received in the base. The base includes a protrusion protruding from a side surface of the base and surrounding the base. The base is received in the slot. The protrusion is fixed to an inner surface of the housing around the slot.

### BACKGROUND

1. Technical Field

The disclosure generally relates to housing assemblies, and particularly to a housing assembly having a speaker module for electronic devices.

2. Description of Related Art

A portable electronic device such as a mobile phone commonly includes a speaker module fixed to a housing of the electronic device. However, a special receiving chamber is usually needed in the housing to accommodate the speaker module with a sound channel corresponding to speaker module to output sound from the speaker module, thus making the structure of the housing complex. In addition, the speaker module is commonly fixed by screws which may increase a thickness of the housing.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a disassembled view of a housing assembly, according to an exemplary embodiment of the disclosure.

FIG. 2 is an assembled view of the housing assembly of FIG. 1

FIG. 3 is a cross-sectional view of the housing assembly in FIG. 2 along line III-III.

### DETAILED DESCRIPTION

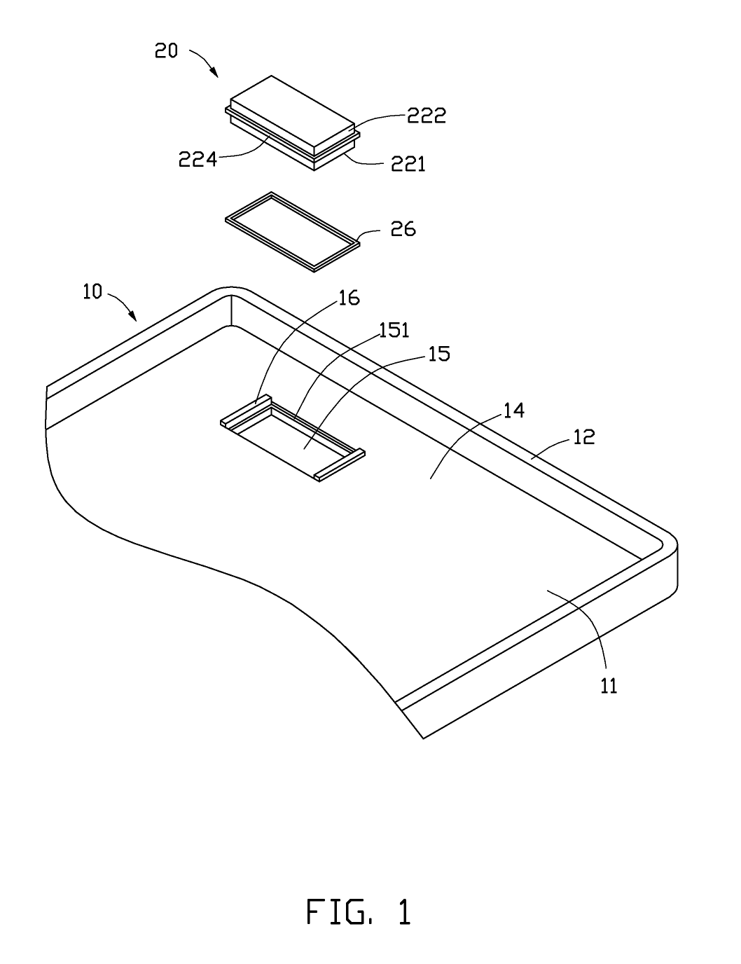

FIG. 1 is a disassembled view of a housing assembly, according to an exemplary embodiment of the disclosure. The housing assembly is used in electronic devices such as mobile phones and computers. The housing assembly includes a housing 10 and a speaker module 20 assembled to the housing 10.

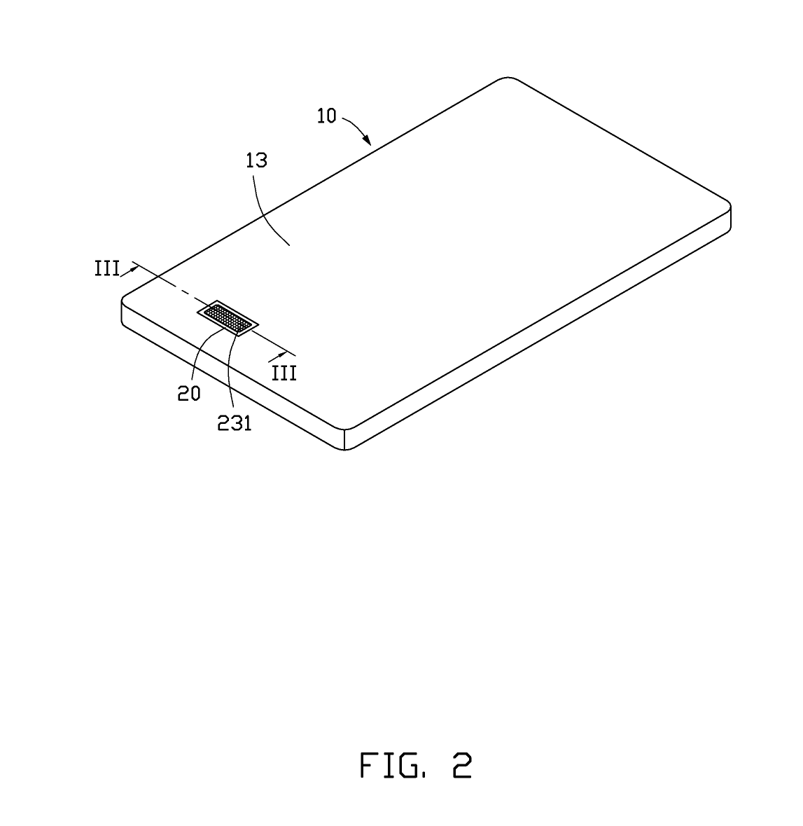

FIG. 2 shows that the housing 10 includes a bottom wall 11 and a side wall 12 extending from a peripheral edge of the bottom wall 11. The bottom wall 11 includes a first surface and an opposite second surface. In this embodiment, the first surface is an outer surface 13 of the bottom wall 11. The second surface is an inner surface 14 of the bottom wall 11. The bottom wall 11 defines a through slot 15 configured for assembling the speaker module 20. A step-shaped recess 151 is formed along a peripheral edge of the slot 15 in the inner surface 14. Two strip-shaped opposite ribs 16 protrude from the inner surface 14 adjacent to the recess 151.

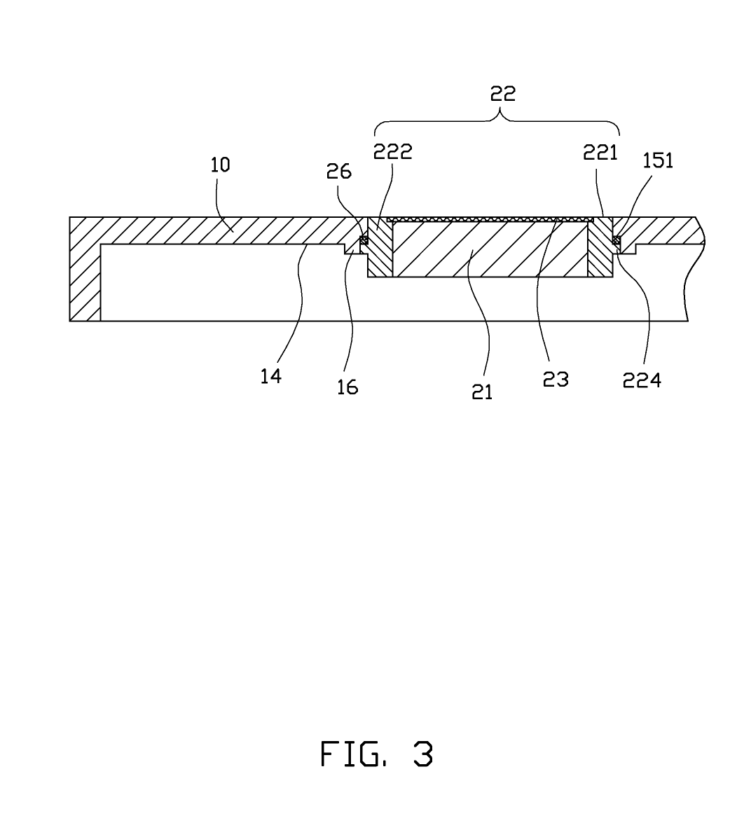

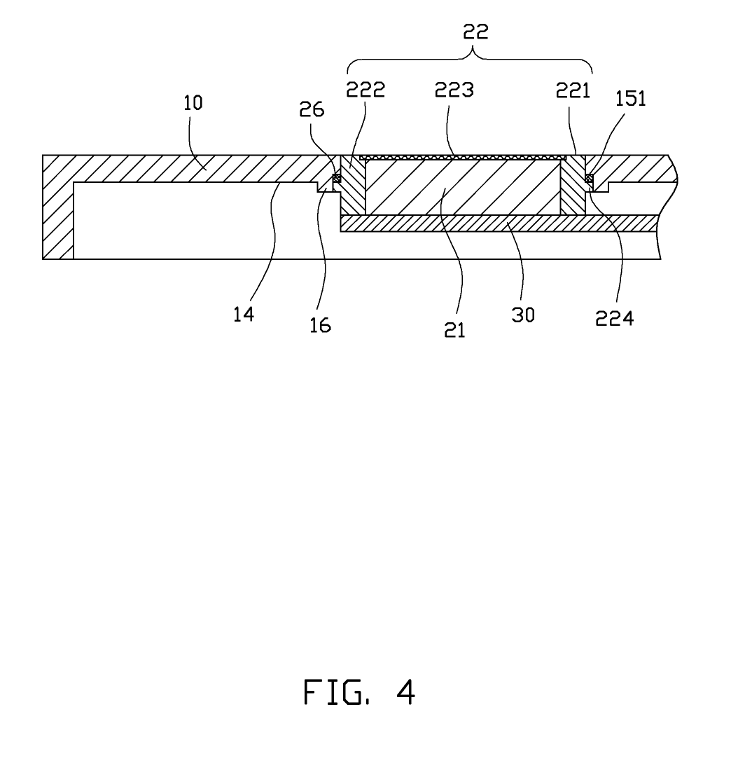

FIG. 3 shows that the speaker module 20 includes a speaker 21 (schematically shown), a base 22, and a cover 23. The speaker 21 is received in the base 22. The base 22 includes a top surface 221, and a side surface 222 extending from a peripheral edge of the top surface 221. A protrusion 224 protrudes from the side surface 222 surrounding the base 22 and parallel to the top surface 221. A distance between the protrusion 224 and the top surface 221 is substantially equal to a thickness of the housing 10. The cover 23 is attached to the top surface 221 to protect the speaker 21. A plurality of sound holes 231 are defined in the cover 23 to output audio signals from the speaker 21. The cover 23 and the base 22 can be formed by integrated molding.

In assembly, the speaker module 21 is received in the slot 15 with the protrusion 224 abutting against the recess 151. The protrusion 224 is adhered to the recess 151. Furthermore, a sealing material 26 such as foam, can be positioned between the protrusion 224 and the recess 151 to seal the recess 151. The speaker module 21 is fixed to the housing 10 with the ribs 16 resisting against two sides of the protrusion 224. The cover 23 is coplanar with the outer surface 13 to provide a smooth surface of the housing 10.

FIG. 4 shows that in other embodiments, the housing assembly further includes a circuit board 30. The circuit board 30 is received in the housing 10 and resists against at one side of the speaker module 20. The speaker module 20 is sandwiched between the housing 10 and the circuit board 30. The sealing material 26 positioned between the speaker module 20 and the housing 10 may be deformed in order to seal the recess 151. Thus, the sealing material 26 provides an elastic force to the speaker module 20 outward of the recess 151, which may lead to the speaker module 20 coming out of from the recess 151. However, the circuit board 30 resists against the speaker module 20 toward the recess 151 to prevent the speaker module 20 from escaping from coming out of the recess 151. In other words, the circuit board 30 resists against the speaker module 20, so the speaker module 20 cannot loosen easily due to elastic force provided by the sealing material 26.

The speaker module 20 is assembled to the housing 10 by fixing the protrusion 224 to the recess 151. Therefore, no extra fasteners are used in the housing assembly so that the housing assembly can have a relative simple structure and thinness.

In other embodiment, the recess 151 can be omitted. The protrusion 224 is directly fixed to the inner surface 14.

In addition, the ribs 16 and the protrusion 224 can be elastic. The protrusion 224 abuts against the inner surface 14 of the housing 10 and is sandwiched between the ribs 16 fixing the speaker module 20 to the housing 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A housing assembly, comprising:
a housing defining a slot; and
a speaker module assembled to the housing, the speaker module comprising:
a speaker; and
a base, the speaker received in the base, the base comprising a protrusion protruding from a side surface of the base; wherein the base is received in the slot, the protrusion is fixed to an inner surface of the housing.

2. The housing assembly of claim 1, the base further comprising a step-shaped recess formed along a peripheral edge of the slot in the inner surface, the protrusion is fixed to the recess.

3. The housing assembly of claim 2, the base further comprising a sealing material positioned between the recess and the protrusion to seal the recess.

4. The housing assembly of claim 2, the base further comprising two opposite ribs protruding from the inner surface adjacent to the recess, the ribs resist against the protrusion.

5. The housing assembly of claim 1, the base further comprising a top surface, the side wall extends from a peripheral edge of the top surface, the protrusion is parallel to the top surface.

6. The housing assembly of claim 5, the base further comprising a cover defining a plurality of sound holes, the cover is attached to the top surface.

7. A housing assembly, comprising:
a housing defining a slot and comprising two opposite ribs protruding from an inner surface of the housing adjacent to the slot; and
a speaker module assembled to the housing, the speaker module comprising:
a speaker; and
a base, the speaker received in the base, the base comprising a protrusion protruding from a side surface of the base and surrounding the base; wherein the base is received in the slot, the protrusion abuts against an inner surface of the housing and is sandwiched between the ribs.

8. The housing assembly of claim 7, the base further comprising a step-shaped recess formed along a peripheral edge of the slot in the inner surface, the protrusion abuts against the recess.

9. The housing assembly of claim 8, the base further comprising a sealing material positioned between the recess and the protrusion to seal the recess.

10. The housing assembly of claim 7, the base further comprising a top surface, the side wall extends from a peripheral edge of the top surface, the protrusion is parallel to the top surface.

11. The housing assembly of claim 10, the base further comprising a cover defining a plurality of sound holes, the cover is attached to the top surface.

12. A housing assembly, comprising:
a housing, the housing defining a slot, the housing comprising two opposite ribs protruding from an inner surface of the housing adjacent to the slot;
a speaker module assembled to the housing, the speaker module comprising:
a speaker; and
a base, the speaker received in the base, the base comprising a protrusion protruding from a side surface of the base and surrounding the base; wherein the base is received in the slot, the protrusion abuts against an inner surface of the housing and is sandwiched between the ribs; and
a circuit board resisting against the speaker module.

13. The housing assembly of claim 12, the base further comprising a step-shaped recess formed along a peripheral edge of the slot in the inner surface, the protrusion is fixed to the recess.

14. The housing assembly of claim 13, the base further comprising a sealing material positioned between the recess and the protrusion to seal the recess.

15. The housing assembly of claim 13, the base further comprising two opposite ribs protruding from the inner surface adjacent to the recess, the ribs resist against the protrusion.

16. The housing assembly of claim 12, the base further comprising a top surface, the side wall extends from a peripheral edge of the top surface, the protrusion is parallel to the top surface.

17. The housing assembly of claim 16, the base further comprising a cover defining a plurality of sound holes, the cover is attached to the top surface.
